(19) United States
(12) Patent Application Publication
(10) Pub. No.: US 2020/0309203 A1
(43) Pub. Date: Oct. 1, 2020

(54) ROLLER CLUTCH ASSEMBLY

(71) Applicants: Tong Wenliang, Xiamen (CN); Draper, Inc., Spiceland, IN (US)

(72) Inventors: Kenneth M. Risher, Indianapolis, IN (US); Tong Wenliang, Xiamen (CN)

(21) Appl. No.: 16/832,661

(22) Filed: Mar. 27, 2020

Related U.S. Application Data
(60) Provisional application No. 62/826,437, filed on Mar. 29, 2019.

(51) Int. Cl. F16D 13/76; E06B 9/68

(52) U.S. Cl. CPC F16D 13/76; F16D 2500/3125; F16D 2300/10; E06B 9/68

(57) ABSTRACT

The present disclosure relates to a roller clutch assembly. The roller clutch assembly includes a beaded chain wheel having an inner radial surface, a drive adapter having a base and an internal channel, the base including a support surface configured to retain the driver adapter along the inner radial surface of the beaded chain wheel, a support shaft configured to extend through the internal channel of the drive adapter, a main shaft positioned around the support shaft, the main shaft having an inner radial surface and an outer radial surface, at least a portion of the outer radial surface being tooled, and a spring positioned around the main shaft, the spring abutting at least a portion of the tooled portion of the outer radial surface. The system also includes at least one pulley for guiding the beaded chain of the roller clutch assembly.

### FIELD OF THE DISCLOSURE

The present disclosure relates to a roller clutch assembly and, more particularly, to a roller clutch assembly having a tooled surface.

### BACKGROUND

Window coverings are typically provided to block ambient light from entering a room. Some window coverings have rollers about which the fabric cover is wound and which allow for the fabric cover to be positioned at any level with respect to the window. The roller may have a clutch assembly supported on the wall or window casing that allows for movement of the fabric cover.

The amount of force required to move the fabric cover is dependent on the clutch assembly of the roller. The smaller the force required to move the fabric cover, the easier the fabric cover is to adjust and support. As such, there is a need for a roller clutch assembly with a reduced pull force.

### SUMMARY

According to an embodiment of the present disclosure, a roller clutch assembly is disclosed. The roller clutch assembly a beaded chain wheel having an inner radial surface, a drive adapter having a base and an internal channel, the base including a support surface configured to retain the driver adapter along the inner radial surface of the beaded chain wheel, a support shaft configured to extend through the internal channel of the drive adapter, a main shaft positioned around the support shaft, the main shaft having an inner radial surface and an outer radial surface, at least a portion of the outer radial surface being tooled, and a spring positioned around the main shaft, the spring abutting at least a portion of the tooled portion of the outer radial surface.

In another embodiment of the present disclosure, a roller clutch and housing assembly is provided. The roller clutch and housing assembly comprises a beaded chain wheel having a circumferential portion and an inner radial surface, a beaded chain configured to be received within the circumferential portion of the beaded chain wheel, a drive adapter having a base and an internal channel, the base including a support surface configured to retain the driver adapter along the inner radial surface of the beaded chain wheel, a support shaft configured to extend through the internal channel of the drive adapter, a main shaft positioned around the support shaft, and a spring positioned around the main shaft, the spring abutting at least a portion of the outer radial surface, and a housing assembly, the housing assembly including an outer cover, an inner cover, and at least two pulleys coupled to the outer cover, at least one channel positioned between the at least two pulleys, the beaded chain of the roller clutch assembly configured to pass through the at least one channel.

Additional features and advantages will become apparent to those skilled in the art upon consideration of the following detailed description.

### BRIEF DESCRIPTION OF THE DRAWINGS

Advantages and features of the embodiments of this disclosure will become more apparent from the following detailed description of exemplary embodiments when viewed in conjunction with the accompanying drawings, wherein:

FIG. 1 is a front perspective view of a first embodiment of a housing assembly and a roller clutch assembly of the present disclosure;

FIG. 2 is a front view of the housing assembly and the roller clutch assembly of FIG. 1;

FIG. 3 is a side view of the housing assembly and the roller clutch assembly of FIG. 1;

FIG. 4 is a front exploded view of the housing assembly and the roller clutch assembly of FIG. 1;

FIG. 5 is a perspective view of a main shaft of the roller clutch assembly of FIG. 1 with knurling having an angled pattern;

FIG. 6a shows an alternative pattern for the knurling for the main shaft of FIG. 5 including lines forming diamonds;

FIG. 6b shows an alternative pattern for the knurling for the main shaft of FIG. 5 including straight vertical lines;

FIG. 6c shows an alternative pattern for the knurling for the main shaft of FIG. 5 including straight horizontal lines;

FIG. 7 is a rear exploded view of the housing assembly of FIG. 1;

FIG. 8 is a rear exploded view of the housing assembly with a portion of the roller clutch assembly coupled to an outer cover of the housing assembly of FIG. 1;

FIG. 9 is a cross-sectional view of the housing and roller clutch assemblies of FIG. 1, taken along line A-A of FIG. 2;

FIG. 10 is a graphical representation of pounds of pull force needed to cause rotation of a clutch assembly with a tooled portion of the present disclosure versus the pounds of pull force needed to cause rotation of a clutch assembly without a tooled portion;

FIG. 11 is a front perspective view of a second housing assembly configured to receive a portion of a roller tube supported by the roller clutch assembly of FIG. 1;

FIG. 12 is a front exploded view of the second housing assembly of FIG. 7 including a removable bracket;

FIG. 13 is a rear exploded view of the second housing assembly of FIG. 7 including a removable bracket;

FIG. 14 is a front exploded view of the housing assembly and the roller clutch assembly of FIG. 1 with a removable bracket along a second side of the housing assembly and the roller clutch assembly;

FIG. 15 is a front exploded view of the housing assembly and the roller clutch assembly of FIG. 1 with a removable bracket along a first side of the housing assembly and the roller clutch assembly;

FIG. 16 is a front exploded view of the second housing assembly of FIG. 10 with a removable bracket along a second side of the second housing assembly;

FIG. 17 is a front exploded view of the second housing assembly of FIG. 10 with a removable bracket along a first side of the second housing assembly;

FIG. 18 is an exploded view of a second embodiment of a housing assembly and a roller clutch assembly of the present disclosure with a support bracket on a first side of the housing assembly; and

FIG. 19 is an exploded view of a third embodiment of a housing assembly and a roller clutch assembly of the present disclosure with a support bracket on a second side of the housing assembly.

Corresponding reference characters indicate corresponding parts throughout the several views. Although the drawings represent embodiments of the present disclosure, the drawings are not necessarily to scale and certain features may be exaggerated in order to better illustrate and explain the present disclosure. The exemplifications set out herein illustrate embodiments of the disclosure, in one form, and such exemplifications are not to be construed as limiting the scope of the disclosure in any manner.

### DETAILED DESCRIPTION OF THE DRAWINGS

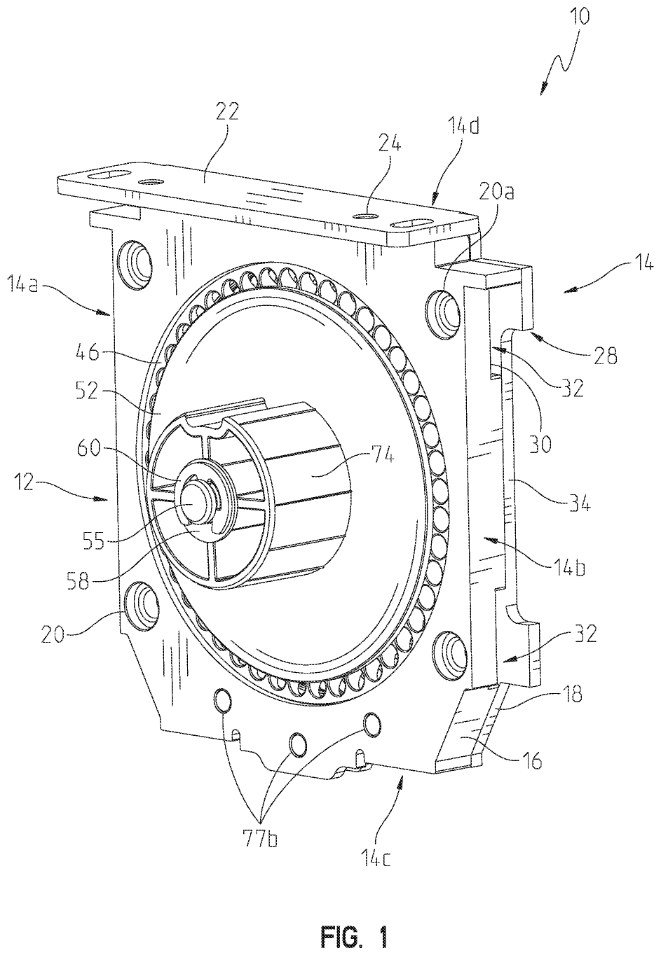

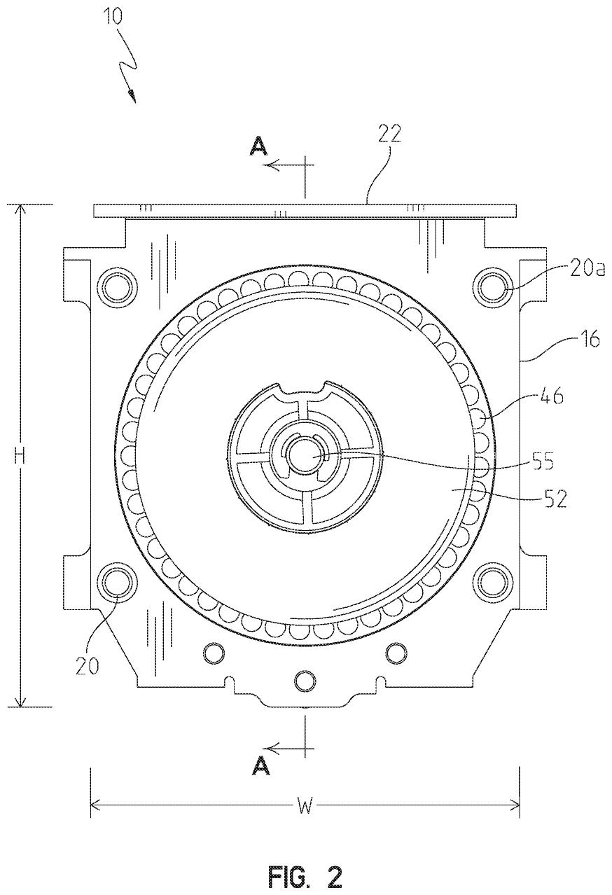

Referring to FIGS. 1-9, a roller clutch and housing assembly 10 for a fabric covering includes a roller clutch assembly 12 and a housing assembly 14. Housing assembly 14 includes an outer cover 16 and an inner cover 18 removably coupled together. Housing assembly 14 is configured to be coupled to a wall, window casing, or other similar structure (not shown) by receiving removable fasteners (e.g., screws) through apertures 20 which extend through outer and inner covers 16, 18. Additionally, inner cover 18 includes a fixed bracket portion 22 configured to be removably coupled to a second portion of the wall or window casing. For example, outer and inner covers 16, 18 may receive fasteners through respective apertures 20a, 20b to couple housing assembly 14 to a vertical portion of a window casing while fixed bracket portion 22 may receive fasteners through apertures 24 to couple housing assembly 14 to a horizontal portion of the window casing. Fixed bracket portion 22 may be integrally formed with a main portion 26 of inner cover 18 or may be separate therefrom but fixedly coupled thereto such that fixed bracket portion 22 has a fixed position relative to main portion 26. Housing assembly 14 may be comprised of a rigid material, such as a rigid polymeric and/or metallic material.

As shown in FIGS. 1-9, housing assembly 14 extends laterally between a first side 14a and a second side 14b and vertically between a third side 14c and a fourth side 14d. Any of sides 14a-d may include one or more fixed bracket portions 22 and, illustratively, fourth side 14d is integrally formed with fixed bracket portion 22. The distance between first and second sides 14a, 14b defines a width W of housing assembly 14, the distance between third and fourth sides 14c, 14d defines a height H of housing assembly 14, and a distance between the exterior faces of outer and inner covers 16, 18 defines a depth D of housing assembly 14.

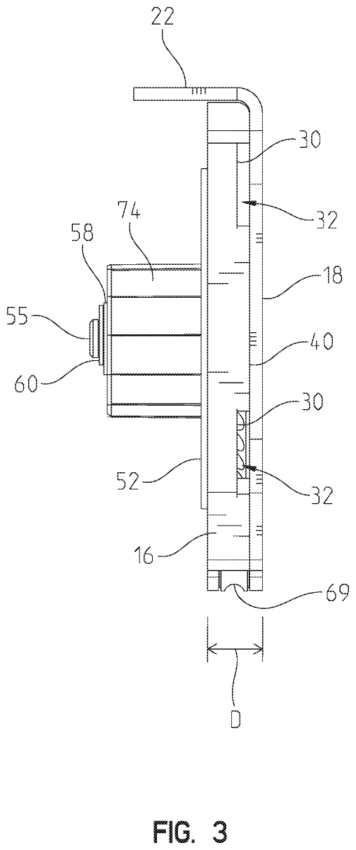

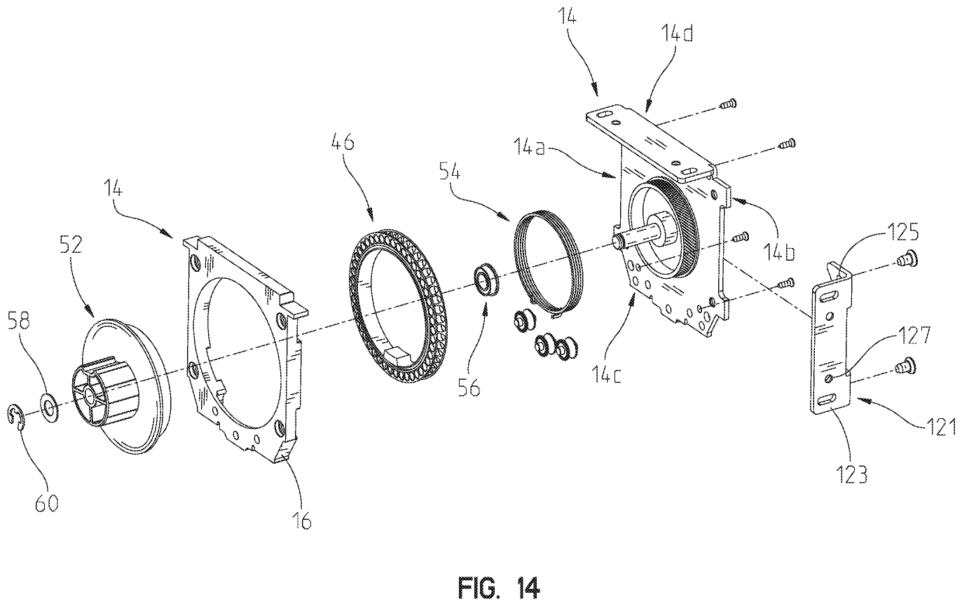

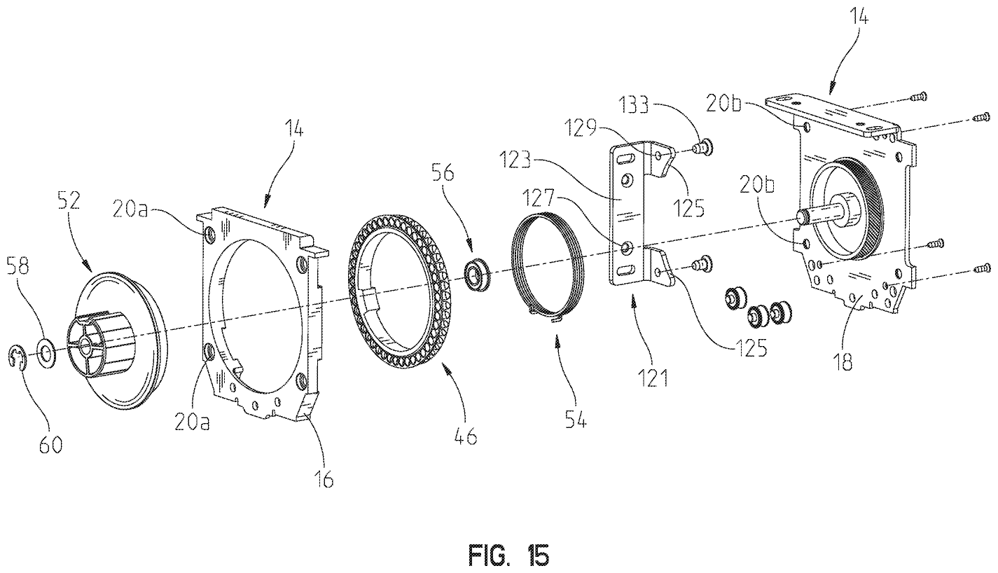

Additionally, any of sides 14a-d may be configured to couple with a removable bracket 121, as disclosed further herein (see FIGS. 14 and 15). More particularly, outer and inner covers 16, 18 cooperate with each other when coupled together to form a receiving portion 28 for joining with the removable bracket. Illustratively, as shown in FIGS. 1 and 3, receiving portion 28 is defined by recesses 30 on outer cover 16 which, when outer cover 16 is coupled with inner cover 18, define slots 32. In one embodiment, housing assembly 14 includes two slots 32 along any of sides 14a-d and slots 32 are spaced apart by a protrusion 34 on outer cover 16 which extends towards inner cover 18. In this way, when outer cover 16 is coupled to inner cover 18, protrusion 34 may contact inner cover 18 while recesses 30 of outer cover 16 are spaced apart therefrom to define slots 32. Slots 32 are configured to receive at least a portion of a removable bracket, as disclosed further hereinafter. In one embodiment, one or more of sides 14a-d includes a single slot 32.

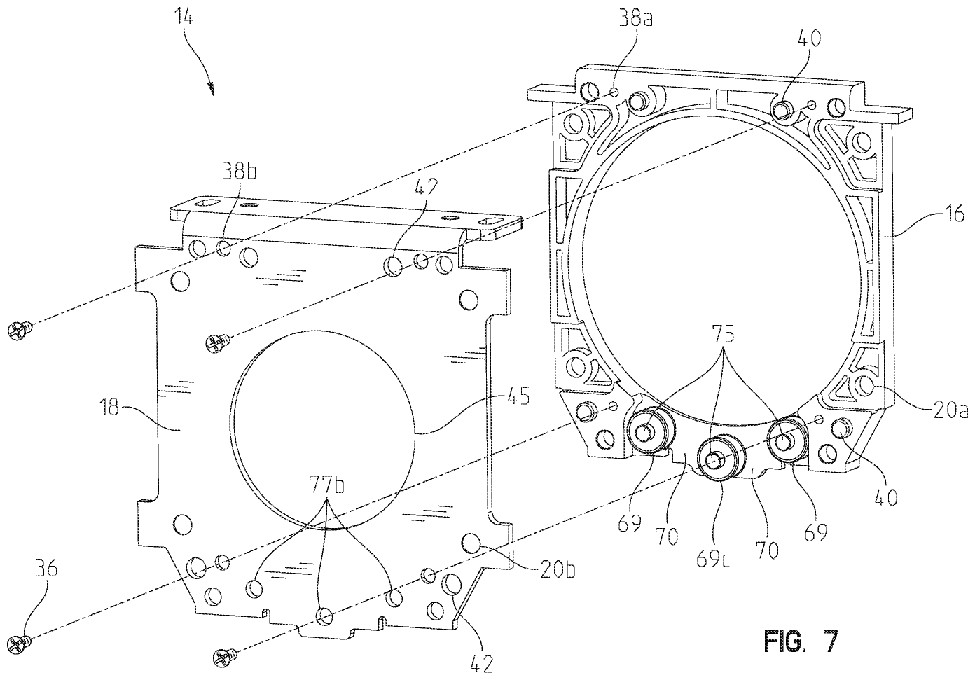

As shown in FIG. 7, outer and inner covers 16, 18 are coupled together with removable fasteners 36 (e.g., screws) which are received through openings 38b of inner cover 18 and into openings 38a of outer cover 16. In this way, the head of fasteners 36 is positioned along the innermost surface of inner cover 18 such that they are not visible when housing assembly 14 is mounted to a wall, window casing, or other similar surface. Outer cover 16 also is retained on inner cover 18 using pins 40 projecting from outer cover 16 towards inner cover 18. More particularly, pins 40 are received within openings 42 on inner cover 18. As such, outer and inner covers 16, 18 are coupled together through fasteners 36 and pins 40.

Referring still to FIGS. 1-9, housing assembly 14 supports clutch assembly 12 thereon, which allows a beaded chain 44 or other similar member to raise and lower a fabric covering 90 (FIG. 7) between a raised position and a lowered position. Fabric covering 90 is wound about a roller tube 91. Clutch assembly 12 also may be configured to maintain the position of fabric covering 90 at a position set by the user. Clutch assembly 12 is configured to rotate about an axis a.

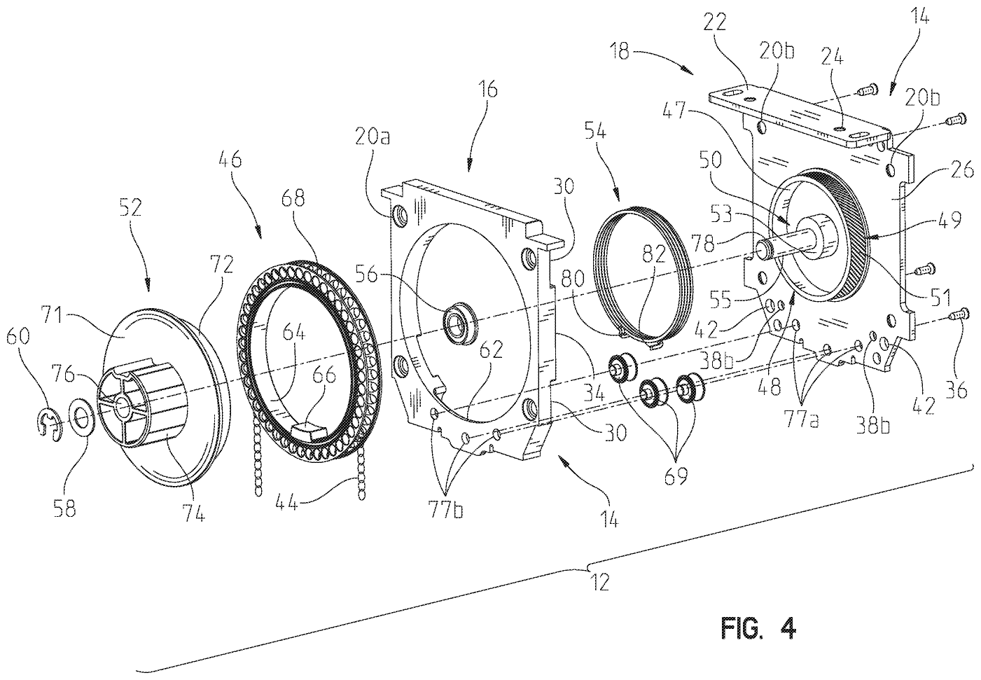

Referring to FIG. 4, clutch assembly 12 includes a beaded chain wheel 46, a main shaft 48, a coupling shaft 50, a drive adapter 52, a spring 54, a guide member 56, a washer 58, and a retention member 60. Beaded chain wheel 46 is supported within an opening 62 of outer cover 16 and is configured to receive at least a portion of drive adapter 52 along an inner radial surface 64. Inner radial surface 64 of beaded chain wheel 46 includes a protrusion 66 extending radially inward therefrom and is configured to engage drive adapter 52 during operation of clutch assembly 12. Further, as known in the art, beaded chain wheel 46 includes a circumferential portion 68 (see FIG. 4) which receives a beaded chain 44 (representative portions shown in FIG. 4). In various embodiments, beaded chain 44 is guided through channels 70 (see FIG. 7) created between pulleys 69 when clutch assembly 12 is assembled to housing assembly 14. Pulleys 69 allow beaded chain 44 to be pulled from various angles and reduces the noise and wear of the assembly by not being fixed. In various embodiments, the center pulley 69c may be an extension integral with or coupled to outer cover 16 such that channels 70 are created between pulleys 69 and the extension of outer cover 16, with the extension being positioned between the two pulleys 69. Pulleys 69 are coupled to outer cover 16 and inner cover 18 using pins 75 projecting from each side of the pulley 69. More particularly, pins 75 are received within openings 77a on inner cover 18 and 77b on outer cover 16, such that when inner and outer cover 16, 18 are coupled together, pulleys 69 are held in place by pins 75 within openings 77a, 77b.

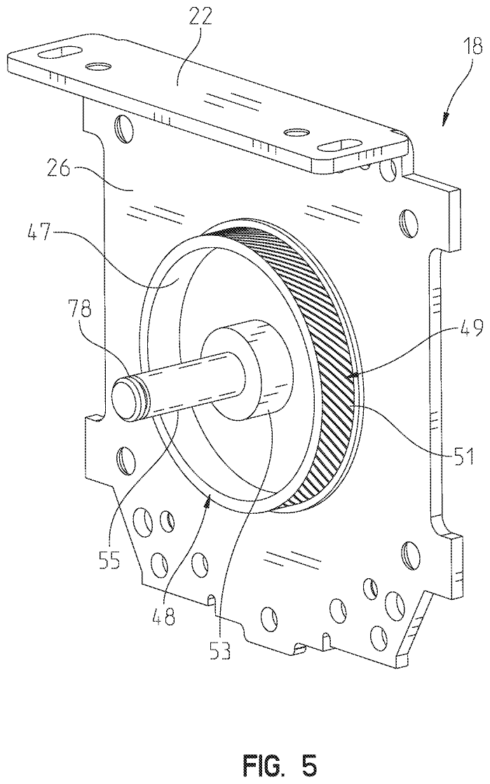

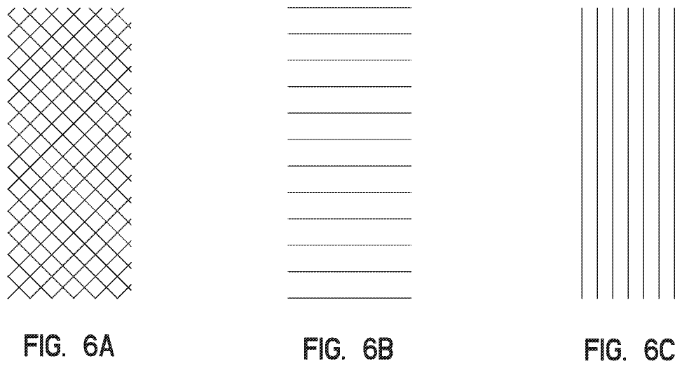

Main shaft 48 extends from inner cover 18 and includes an inner radial surface 47 and an outer radial surface 49. In various embodiments, main shaft 48 may extend from inner cover 18 approximately 0.2 inches to 0.4 inches, and more preferably approximately 0.33 inches. Furthermore, in various embodiments, main shaft 48 may be integral with inner cover 18, while in other various embodiments, main shaft 48 may be coupled to inner cover 18. For example, main shaft 48 may be press fit into an opening 45 of inner cover 18. Outer radial surface 49 of main shaft 48 includes a tooled portion 51. In various embodiments, tooled portion 51 is a knurling or an etching, and may be of various shapes and sizes. For example, tooled portion 51 may include angled lines, vertical lines, horizontal lines, and/or diamond configurations (see FIGS. 5 and 6a-c). The angled lines of the tooled portion 51 may be angled forward or rearward of vertical at approximately 45°. In various embodiments, the diamond configuration may include both forward and rearward angled lines to create the diamond configuration. Tooled portion 51 may also extend an entire length or width of main shaft 48 or only a portion thereof.

In various embodiments, tooled portion 51 is rolled on the surface of main shaft 48, while in other various embodiments, tooled portion 51 is cut into the surface of main shaft 48. The depth of the tooled portion may be approximately 0.01 inches to 0.02 inches, while the distance between subsequent lines of the tooled portion may be approximately 0.005 inches to approximately 0.1 inches. In various embodiments, the depth of the tooled portion is approximately 0.012 inches to 0.015 inches, and the distance between subsequent lines of the tooled portion is approximately 0.06 inches.

Coupling shaft 50 extends from inner cover 18 and is positioned internal to main shaft 48. In various embodiments, coupling shaft 50 includes a base 53 and a shaft 55, where a diameter of base 53 is greater than a diameter of shaft 55.

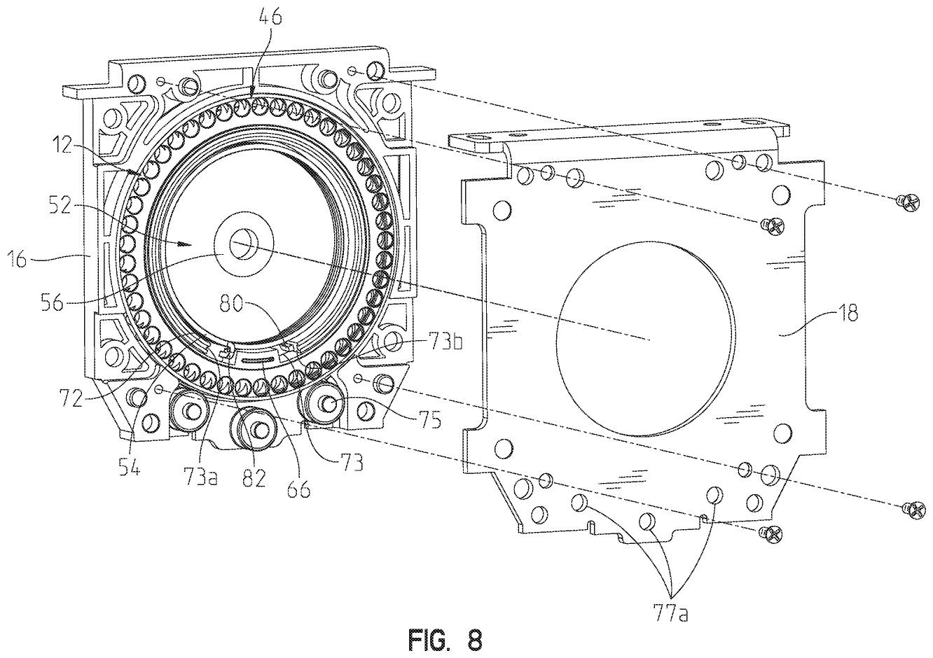

Drive adapter 52 includes a base 71, and a support surface 72 extending from base 71 which retains drive adapter 52 along inner radial surface 64 of beaded chain wheel 44. Support surface 72 includes an opening 73 (see FIG. 8) configured to receive protrusion 66 of beaded chain wheel 46. Drive adapter 52 also includes a nose 74 which extends outward from base 71. Nose 74 includes an internal channel 76 configured to receive a portion of coupling shaft 50. More particularly, shaft 55 of coupling shaft 50 is received through channel 76 when drive adapter 52 and coupling shaft 50 and/or inner cover 18 are coupled together. Guide member 56 also is received on shaft 55 of coupling shaft 50 for aligning and coupling shaft 50 and inner cover 18 with drive adapter 56. In various embodiments, guide member 56 is a bearing received within base 71 of drive adapter 52. Shaft 55 extends through nose 74 and inner cover 18 and coupling shaft 50 and drive adapter 56 are further coupled together with washer 58 and retention member 60. In one embodiment, retention member 60 is a C-clip frictionally retained within a groove 78 on shaft 55 to prevent axial movement of inner cover 18, coupling shaft 50 and main shaft 48 relative to drive adapter 56.

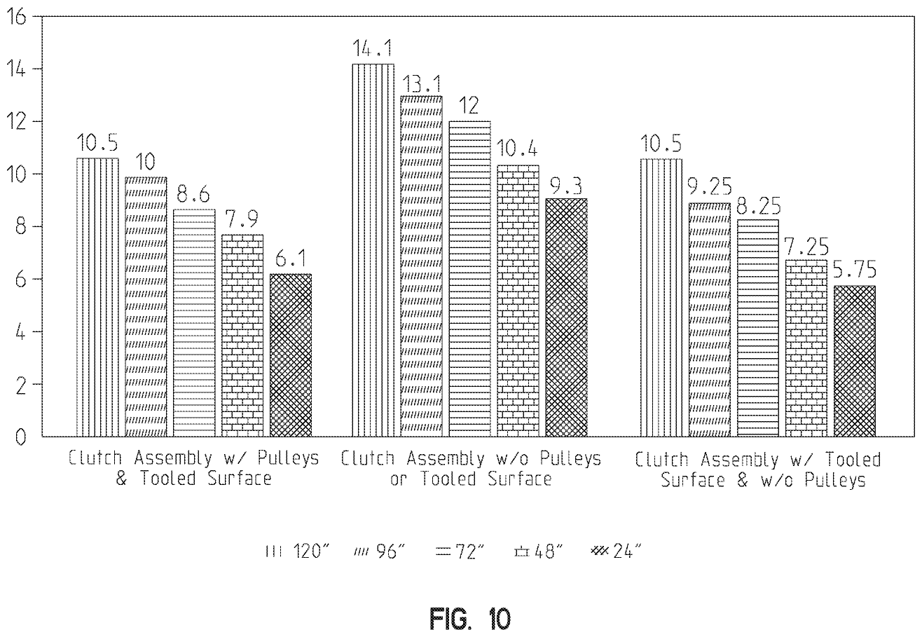

Spring 54 includes a first tang 80 and a second tang 82 and wraps around main shaft 48. At least a portion of spring 54 abuts some or all of tooled portion 51. The pattern, spacing, depth, and intensity of tooled portion 51, combined with the contact force of spring 54 acting upon it may be used for a wide variety of operating forces and the resultant hold torque. The tuneable, controlled friction created between tooled portion 51 and spring 54 allows a less constrictive spring to be used around main shaft 48 (compared to non-tooled main shafts) which in turn requires a lower force to cause rotation of the clutch assembly. For example, and with reference to FIG. 10, the amount of pull force of clutch assembly 12 (or force (in pounds) a person would be required to apply to cause rotation of the clutch assembly in the upward direction) may be reduce by at least approximately 20% as compared to the amount of pull force needed to cause rotation of a similar clutch assembly that does not include tooled portion 51. In various embodiments, this amount of force may be reduced up to approximately 40%. For example, when clutch assembly 12 supports a 24″ roller body and includes tooled surface 51 and pulleys 69, the amount of pull force of clutch assembly 12 is approximately 6.1 pounds as compared to 9.3 pounds for a similar clutch assembly that does not include tooled surface 51. As such, the amount of pull force of clutch assembly 12 is reduce by approximately 34%. Furthermore, the inclusion of pulleys 69 may affect the amount of pull force for clutch assembly 12. When clutch assembly 12 includes pulleys 69 in addition to tooled surface 51, the amount of pull force of clutch assembly 12 is approximately 6.1 pounds as compared to 5.75 pounds for a similar clutch assembly 12 that includes tooled surface 51, but does not include pulleys 69. Table 1 below provides the amounts of pull force in pounds for the various clutch assemblies supporting 24″, 48″, 72″, 96″, and 120″ roller bodies, while Table 2 below provides percentage differences of the amount of pull forces for the various clutch assemblies. In the examples provided in FIG. 10 and Tables 1 and 2 below, tooled portion 51 includes a diamond pattern across the width of main shaft 48, which is approximately 0.33 inches, where the diamond pattern includes both forward and reverse 45 degree angled lines each having a depth of approximately 0.012-0.015 inches and each of the forward 45 degree angled lines and each of the reverse 45 degree angled lines being spaced approximately 0.6 inches apart from one another to create 0.06 inch by 0.06 inch squares between the forward and reverse 45 degree angled lines.

TABLE 1
Amount of Pull Force in Pounds

| | 24″ | 48″ | 72″ | 96″ | 120″ |
|---|---|---|---|---|---|
| | Roller | Roller | Roller | Roller | Roller |
| | Body | Body | Body | Body | Body |
| | Pull force | Pull force | Pull force | Pull force | Pull force |
| | (lbf) | (lbf) | (lbf) | (lbf) | (lbf) |
| Clutch | 9.30 | 10.4 | 12.0 | 13.1 | 14.1 |
| Assembly | | | | | |
| w/o Tooled | | | | | |
| Surface | | | | | |
| or Pulleys | | | | | |
| Clutch | 6.10 | 7.90 | 8.60 | 10.0 | 10.5 |
| Assembly | | | | | |
| w/Tooled | | | | | |
| Surface | | | | | |
| and Pulleys | | | | | |
| Clutch | 5.75 | 7.25 | 8.25 | 9.25 | 10.5 |
| Assembly | | | | | |
| w/Tooled | | | | | |
| Surface, | | | | | |
| w/o Pulleys | | | | | |

TABLE 2
Differences in Pull Forces
(Clutch Assembly w/o Tooled Surface vs. Clutch
Assembly w/Tooled Surface & w/or w/o Pulleys)

| | 24″ | 48″ | 72″ | 96″ | 120″ |
|---|---|---|---|---|---|
| | Roller | Roller | Roller | Roller | Roller |
| | Body | Body | Body | Body | Body |
| | Pull force | Pull force | Pull force | Pull force | Pull force |
| | (lbf) | (lbf) | (lbf) | (lbf) | (lbf) |
| % Difference | −34.42% | −24.05% | −28.35% | −23.70% | −25.55% |
| (w/pulleys) | | | | | |
| % Difference | −38.20% | −30.30% | −31.25% | −29.40% | −25.55% |
| (w/o pulleys) | | | | | |

In addition, the friction between tooled portion 51 and spring 54 also increases the amount of force required before spring 54 begins rotating around main shaft 48 when tightened. For instance, the friction between tooled portion 51 and spring 54 increases the torque force required to rotate spring 54 in a tightened state around main shaft 48 to 175-200 pounds as compared to 125 pounds when the tooled portion 51 is not provided. At the same time, the tooled portion 51 allows spring 54 to rotate approximately 10-20 degrees without breaking when fabric covering 90 is quickly released.

With reference to FIG. 8, first tang 80 and second tang 82 are spaced apart and configured to receive protrusion 66 of beaded chain wheel 46. Tangs 80 and 82 and protrusion 66 are configured such that tangs 80 and 81 are spaced apart from protrusion 66 when protrusion 66 is received therebetween. When drive adapter 52, main shaft 48, coupling shaft 50, and beaded chain wheel 46 are coupled together, first tang 80 and second tang 82 are positioned within opening 73 of support surface 72 between protrusion 66 and first and second side walls 73a, 73b of opening 73, respectively.

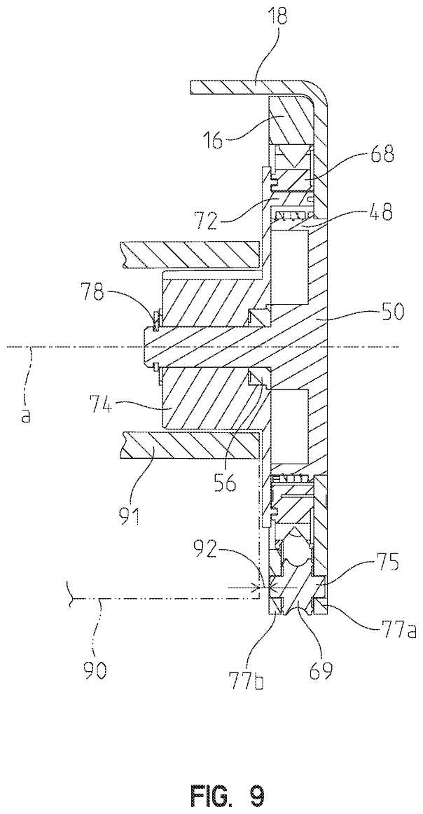

In operation, when a roller 91 (see FIG. 9), which supports fabric covering 90, is coupled to roller clutch and housing assembly 10, one end (e.g., a first or proximal end) of roller 91 receives at least nose 74 of drive adapter 52 of clutch assembly 12 to allow fabric covering 90 to move between the raised and lowered positions and also allow fabric covering 90 to be maintained at a position desired by the user. It may be appreciated that the proximal end of the roller may receive the entirety of nose 74 such that the roller and fabric covering 90 are positioned close to housing assembly 14. In this way, any light gap 92, defined as the distance between fabric covering 90 and housing assembly 14, is minimized, as shown best in FIG. 9.

When beaded chain 44 is pulled, the force causes beaded chain wheel 46 to rotate until first tang 80 or second tang 82 is pinched between protrusion 66 of beaded chain wheel 46 and first side wall 73a or second side wall 73b such that protrusion 66 engages spring 54 and loosens or unwraps spring 54 allowing rotation of beaded chain wheel 46, spring 54, drive adapter 52 and thus roller 91 around main shaft 48. Rotation about main shaft 48 continues until no more force is applied to beaded chain 44 and spring 54 is tightened by first side wall 73a or second side wall 73b engages tangs 80 and/or 82 tightening or wrapping spring 54 such that spring 54 is caught around tooled portion 51 and main shaft 48.

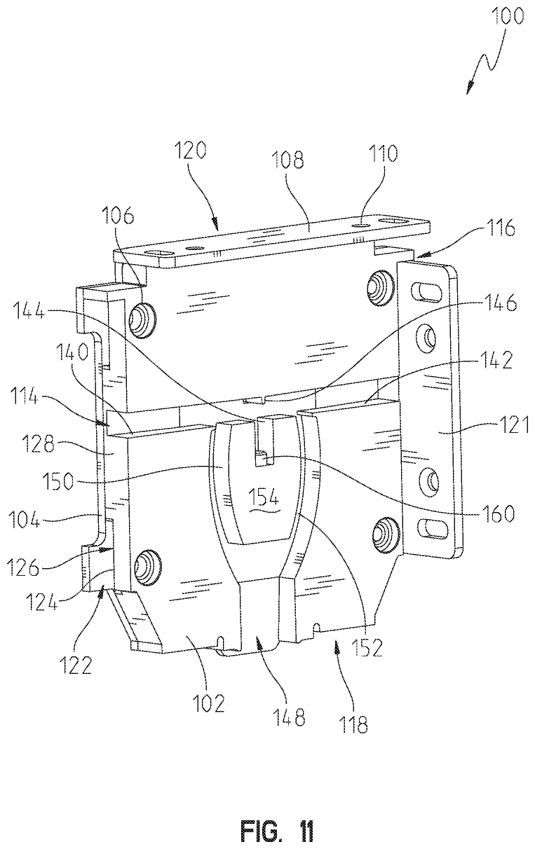

To further support the roller and fabric covering 90, a second or idler housing assembly 100 is configured to receive the second or distal end of roller 91. For example, second housing assembly 100 is positioned at an opposing end of a window casing, wall, or similar structure at a distance from housing assembly 14 that allows the roller to be supported on both housings 14, 100. Referring now to FIGS. 11-13, second housing assembly 100 includes an outer cover 102 and an inner cover 104 removably coupled together. Second housing assembly 100 is configured to be coupled to the wall, window casing, or other similar structure (not shown) by receiving removable fasteners (e.g., screws) through apertures 106 which extend through outer and inner covers 102, 104. Additionally, inner cover 104 includes a fixed bracket portion 108 configured to be removably coupled to a second portion of the wall or window casing. For example, outer and inner covers 102, 104 may receive fasteners through respective apertures 106a, 106b to couple second housing assembly 100 to a vertical portion of a window casing while fixed bracket portion 108 may receive fasteners through apertures 110 to couple inner cover 104 to a horizontal portion of the window casing. Fixed bracket portion 108 may be integrally formed with a main portion 112 of inner cover 104 or may be separate therefrom but fixedly coupled thereto. It may be appreciated that fixed bracket portion 108 has a fixed position relative to main portion 112. Second housing assembly 100 may be comprised of a rigid material, such as a rigid polymeric and/or metallic material.

As shown in FIGS. 11-13, second housing assembly 100 extends laterally between a first side 114 and a second side 116 and vertically between a third side 118 and a fourth side 120. Any of sides 114, 116, 118, 120 may include one or more fixed bracket portions 108 and, illustratively, fourth side 120 is integrally formed with fixed bracket portion 108.

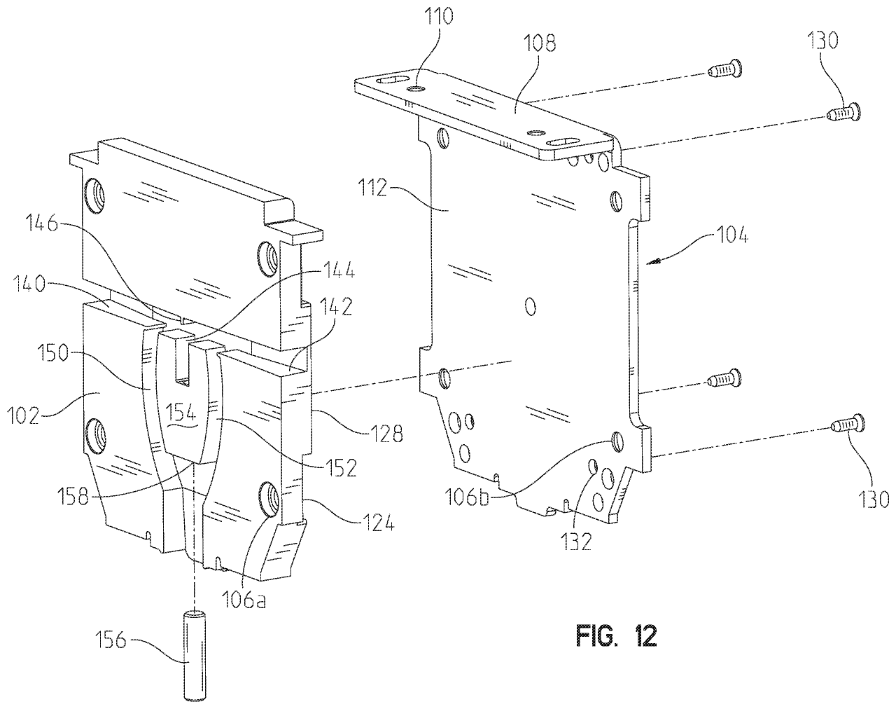

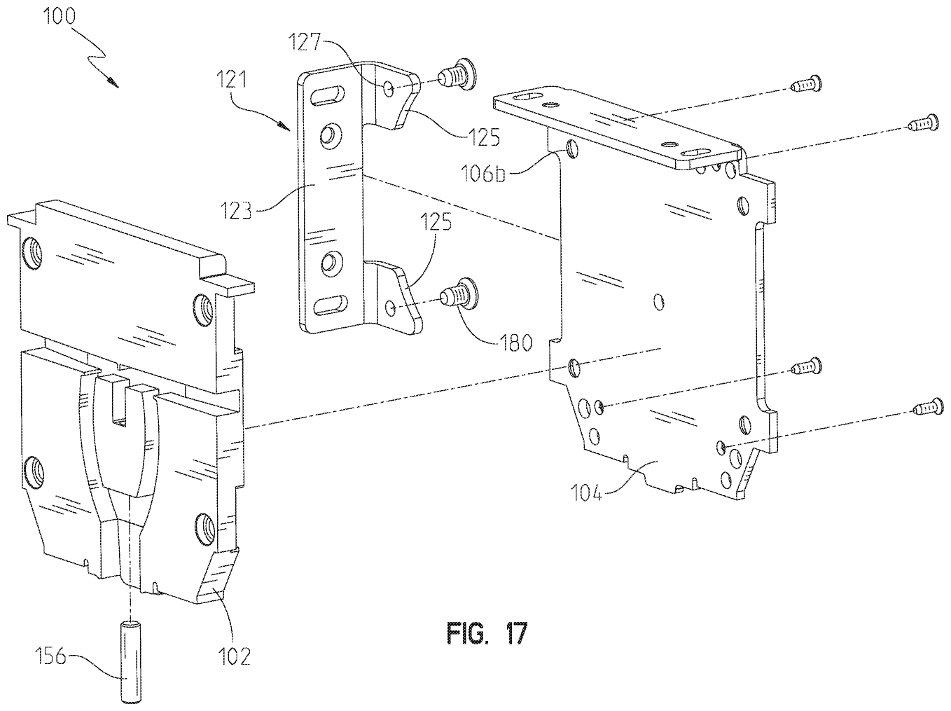

Additionally, any of sides 114, 116, 118, 120 may be configured to couple with a removable bracket 121, as disclosed further herein (see FIGS. 11, 13, 16 and 17). More particularly, outer and inner covers 102, 104 cooperate with each other when coupled together to form a receiving portion 122 for joining with the removable bracket 121. Illustratively, as shown in FIGS. 11 and 12, receiving portion 122 is defined by recesses 124 on outer cover 102 which, when outer cover 102 is coupled with inner cover 104, define slots 126. In one embodiment, second housing assembly 100 includes two slots 126 along any of sides 114, 116, 118, 120 and slots 126 are spaced apart by a protrusion 128 on outer cover 102 which extends towards inner cover 104. In this way, when outer cover 102 is coupled to inner cover 104, protrusion 128 may contact inner cover 104 while recesses 124 of outer cover 102 are spaced apart therefrom to define slots 126. Slots 126 are configured to receive at least a portion of a removable bracket, as disclosed further hereinafter. In one embodiment, one or more of sides 114, 116, 118, 120 includes a single slot 126.

As shown in FIGS. 11-13, outer and inner covers 102, 104 are coupled together with removable fasteners 130 (e.g., screws) which are received through openings 132b of inner cover 104 and into openings 132a of outer cover 102. In this way, the head of fasteners 130 is positioned along the innermost surface of inner cover 104 such that they are not visible when second housing assembly 100 is mounted to a wall, window casing, or other similar surface. Outer cover 102 also is retained on inner cover 104 using locators, illustratively pins 134, projecting from outer cover 102 towards inner cover 104. More particularly, pins 134 are received within openings 136 on inner cover 104. As such, outer and inner covers 102, 104 are coupled together through fasteners 130 and pins 134.

Referring still to FIGS. 11 and 12, outer cover 102 includes a plurality of channels configured to receive the distal end (not shown, for example a round pin) of roller 91. Illustratively, outer cover 102 includes a first channel 140 extending inwardly from first side 114 of second housing assembly 100 and a second channel 142 extending inwardly from second side 116 of second housing assembly 100. In this way, the distal end of the roller may be positioned in either of first or second channels 140, 142, depending on the position of second housing 100 relative to the window casing, wall, etc. The distal end of the roller can be positioned at the laterally outer opening of either of channels 140, 142 to move or slide inwardly towards a retention channel 144 configured to maintain the position of the roller thereon. In one embodiment, retention channel 144 extends vertically and generally perpendicularly to first and second channels 140, 142, however, in other embodiments, retention channel 144 may have a different orientation or configuration. Once the distal end of the roller slides inwardly towards retention channel 144, the distal end of the roller is positioned over retention channel 144 when the distal end contacts detent 146, which is generally vertically aligned with retention channel 144. Detent 146 allows the user or installer to guide the distal end of the roller towards retention channel 144 even if retention channel 144 is not visible to the user or installer.

Additionally, and still referring to FIGS. 11 and 12, depending on the position of second housing assembly 100 relative to the window casing, wall, or other structure, it may be necessary to join the distal end of the roller with second housing assembly 100 from third end 118. More particularly, third end 118 may include an opening 148 which feeds into a third channel 150 and a fourth channel 152. In one embodiment, third and fourth channels 150, 152 extend in a generally vertical direction and open into first and second channels 140, 142, respectively. Third and fourth channels 150, 152 are defined by a protrusion or guide member 154, which also defines retention channel 144. Illustratively, guide member 154 is positioned laterally intermediate third and fourth channels 150, 152 and vertically intermediate opening 148 and first and second channels 140, 142.

If the user or installer chooses to assemble the roller with second housing assembly 100 using opening 148, the distal end of the roller may move through opening 148 and into either third or fourth channel 150, 152 before being received within respective first or second channel 140, 142. Again, once the distal end of the roller moves within first or second channel 140, 142 and contacts detent 146, the distal end can be moved downwardly into retention channel 144 to secure the distal end to second housing assembly 100.

Once the distal end of the roller is received within retention channel 144, the distal end is supported by a pin 156 positioned within retention channel 144. As shown best in FIGS. 11 and 12, pin 156 is received within an aperture 158 of guide member 154 and an upper extent 160 of pin 156 is exposed within retention channel 144 while the remainder of pin 156 is concealed by guide member 154. Pin 156 may be removably coupled to, or otherwise support, the distal end of the roller for coupling the roller to second housing assembly 100. In embodiments, pin 156 includes a threaded exterior which is threaded into aperture 158 of guide member 154 such that upper extent 160 of pin 156 may be raised or lowered relative to guide member 154. An advantage, among others, of this adjustability is to assist in raising or lowering one end of roller 91 to level roller 91 relative to the environment. In other embodiments, pin 156 is not threaded, but is one of a plurality of pins 156 that may be selected for insertion into aperture 158, each of the plurality of pins 156 having a different height.

Referring to FIGS. 14 and 15, housing assembly 14 may be coupled with a removable bracket 121. Illustratively, as shown in FIG. 14, removable bracket 121 may be coupled to housing assembly 14 along first side 14a and/or, as shown in FIG. 15, removable bracket 121 may be coupled to housing assembly 14 along second side 14b. Removable bracket 121 may be comprised of a rigid polymeric material and includes a body portion 123 and at least one tab 125. Body portion 123 includes apertures 127 which are configured to receive removable fasteners (e.g., screws) to couple removable bracket 121 and housing assembly 14 to the window casing, wall, or other similar structure.

In one embodiment, and referring still to FIGS. 14 and 15, removable bracket 121 includes two tabs 125, each of which includes an aperture 129. Tabs 125 are configured to generally straddle a portion of clutch assembly 12. More particularly, the upper tab 125 of removable bracket 121 aligns with the upper apertures 20a, 20b of outer and inner covers 16, 18, respectively, while the lower tab 125 of removable bracket 121 aligns with the lower apertures 20a, 20b, of outer and inner covers 16, 18, respectively. Tabs 125 are positioned at least partially above and at least partially below a portion of clutch assembly 12 but do not interfere with clutch assembly 12 when removable bracket 121 is coupled to housing assembly 14.

Removable bracket 121 is removably coupled to housing assembly 14 with removable fasteners 133 (e.g., screws) which are received through apertures 20b of inner cover 18, through apertures 129 of tabs 125, and terminate within a portion of apertures 20a of outer cover 16. In this way, one set of fasteners 180 may be used to couple together outer and inner covers 16, 18 of housing assembly 14 and simultaneously couple removable bracket 121 to housing assembly 14.

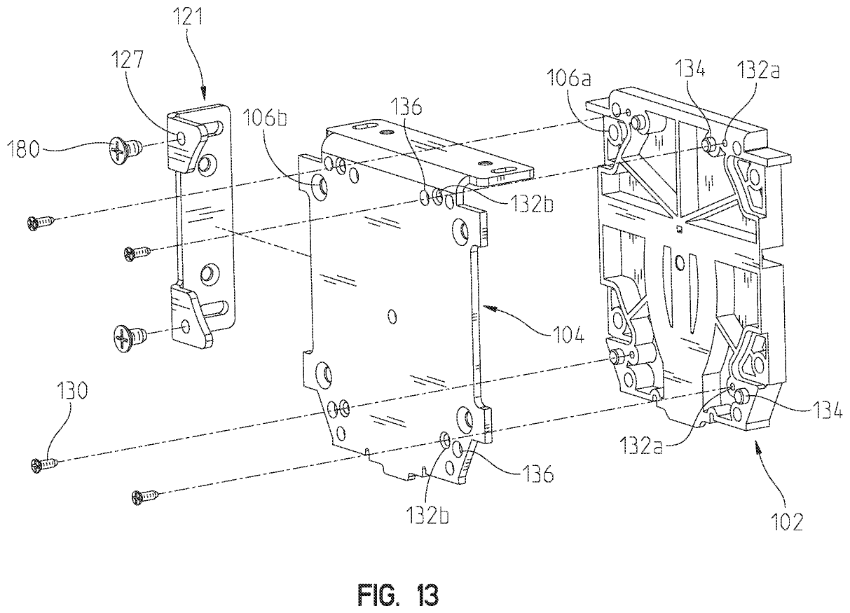

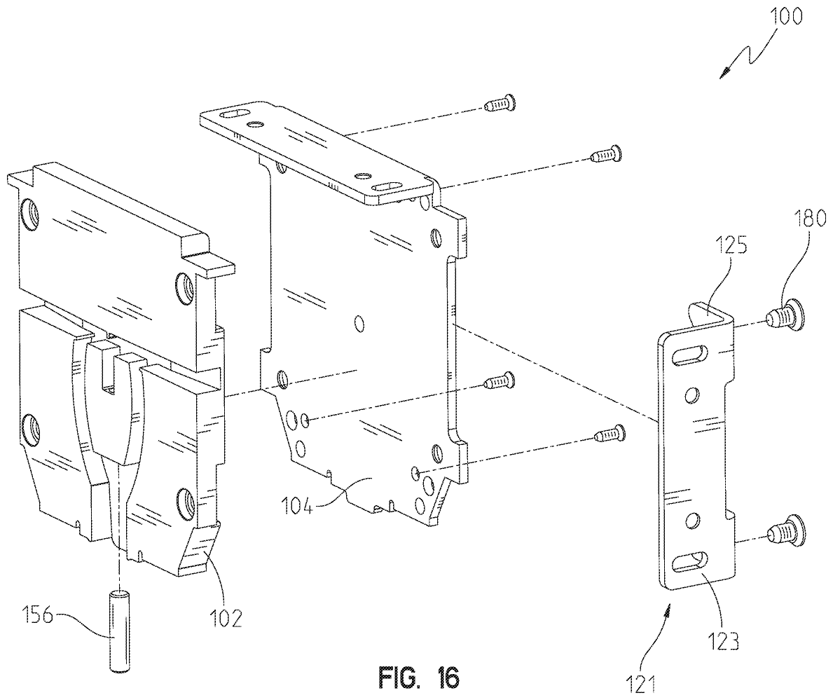

Referring to FIGS. 13, 16 and 17, second housing assembly 100 also is configured to couple with removable bracket 121 along either of first side 114 (FIGS. 11, 13 and 17) and/or second sides 116 (FIG. 16). More particularly, removable bracket 121 is removably coupled to second housing assembly 100 with removable fasteners 180 (e.g., screws) which are received through apertures 106b of inner cover 104, through apertures 127 of tabs 125, and terminate within a portion of apertures 106a of outer cover 102. In this way, one set of fasteners 180 may be used to couple together outer and inner covers 102, 104 of second housing assembly 100 and simultaneously couple removable bracket 121 to second housing assembly 100.

By using removable bracket 121 to couple housing assemblies 14, 100 to the window casing, wall, or other similar structure, the user or installer is able to support clutch assembly 12, roller 91, and fabric covering 90 (FIG. 9) on two surfaces because housing assemblies 14, 100 may be coupled to a first surface and removable bracket 121 may be coupled to a second surface. In this way, regardless of the configuration of the wall, window casing, etc., removable bracket 121 can be positioned to either side of housing assemblies 14, 100 for coupling to the wall, window, etc.

It is possible to couple together multiple housing assemblies 14. In this way, multiple rollers and fabric coverings 90 (FIG. 9) may be positioned in parallel (i.e., axes A of adjacent clutch assemblies 12 are parallel) to accommodate various options for providing covering to a window or wall area. For example, two housing assemblies 14 may be aligned such that first side 14a of one of housing assemblies 14 is positioned adjacent second side 14b of the other housing assembly 14. In this configuration, clutch assemblies 12 of housing assemblies 14 are parallel to each other and can accommodate parallel rollers. Housing assemblies 14 may be coupled together with a joining member generally defining an “I” shape having four tabs such that two tabs may be coupled with each of the housing assembles 14.

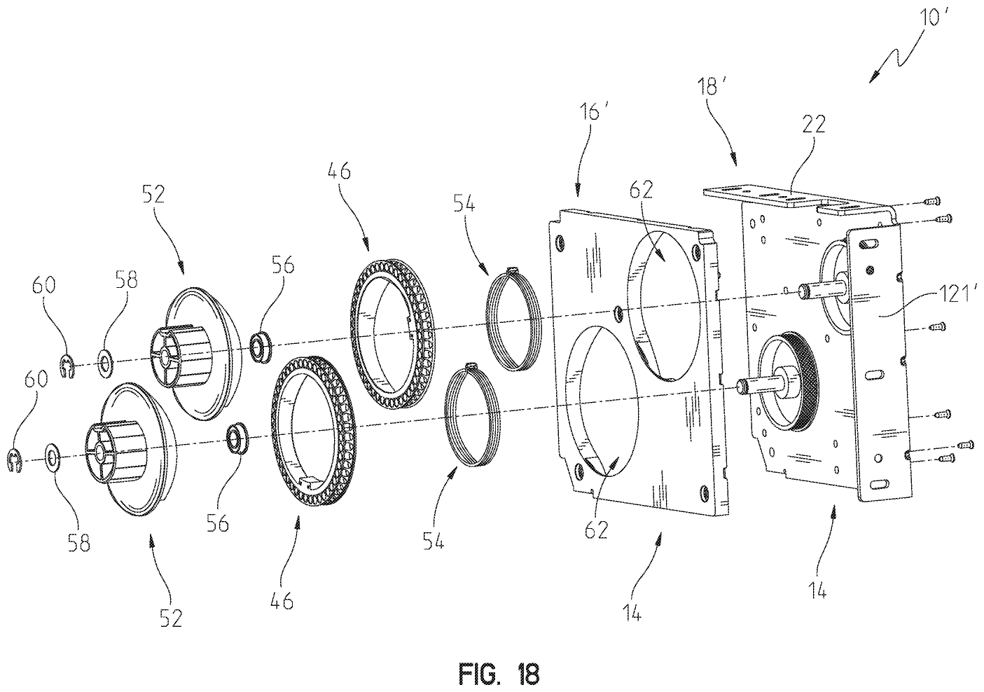

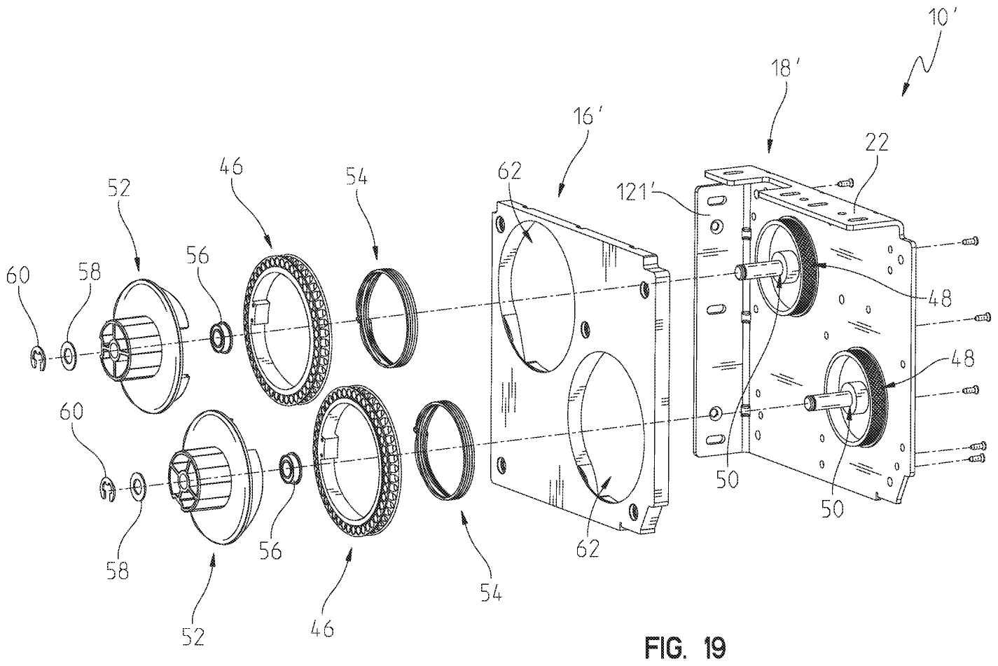

Furthermore, in various embodiments, and with reference to FIGS. 18 and 19, housing assembly 14′ of roller clutch and housing assembly 10′ may be configured to support two clutch assemblies 12. In these embodiments, inner cover 18′ is sized and shaped to support two sets of main shaft 48 and coupling shaft 50, and outer cover 16′ is sized and shaped to include two openings 62 each configured to receive at least a portion of one of clutch assemblies 12. Inner cover 18′ may also include bracket 121′ on either side surface, where bracket 121′ may be removably coupled or fixedly coupled to inner cover 18′. In various embodiments, the two clutch assemblies 12 may be vertical or horizontal aligned, while in other various embodiments, the two clutch assemblies 12 may be horizontal and/or vertically offset (see FIGS. 18 and 19).

While various embodiments of the disclosure have been shown and described, it is understood that these embodiments are not limited thereto. The embodiments may be changed, modified and further applied by those skilled in the art. Therefore, these embodiments are not limited to the detail shown and described previously, but also include all such changes and modifications.

What is claimed is:

1. A roller clutch assembly comprising:
a beaded chain wheel having an inner radial surface;
a drive adapter having a base and an internal channel, the base including a support surface configured to retain the driver adapter along the inner radial surface of the beaded chain wheel;
a support shaft configured to extend through the internal channel of the drive adapter;
a main shaft positioned around the support shaft, the main shaft having an inner radial surface and an outer radial surface, at least a portion of the outer radial surface being tooled; and
a spring positioned around the main shaft, the spring abutting at least a portion of the tooled portion of the outer radial surface.

2. The roller clutch assembly of claim 1, wherein the beaded chain wheel further includes a protrusion extending radially inward from the inner radial surface.

3. The roller clutch assembly of claim 2, wherein the spring includes a first tang and a second tang, the protrusion of the beaded chain wheel being positioned between the first tang and the second tang.

4. The roller clutch assembly of claim 2, wherein the support surface includes an opening configured to receive the protrusion of the beaded chain wheel.

5. The roller clutch assembly of claim 1, wherein the tooled portion of the outer radial surface is at least one of knurled and etched.

6. The roller clutch assembly of claim 1, wherein a pattern of the tooled portion of the outer radial surface of the main shaft includes diagonal lines.

7. The roller clutch assembly of claim 1, wherein a pattern of the tooled portion of the outer radial surface of the main shaft includes horizontal lines.

8. The roller clutch assembly of claim 1, wherein a pattern of the tooled portion of the outer radial surface of the main shaft includes vertical lines.

9. The roller clutch assembly of claim 1, wherein a pattern of the tooled portion of the outer radial surface of the main shaft includes diamond configurations.

10. The roller clutch assembly of claim 1, wherein a pattern of the tooled portion of the outer radial surface of the main shaft includes at least two of diagonal lines, horizontal lines, vertical lines, and diamond shapes.

11. The roller clutch assembly of claim 1, wherein the tooled portion of the outer radial surface of the main shaft includes a majority of the outer radial surface.

12. The roller clutch assembly of claim 1, wherein the tooled portion of the outer radial surface of the main shaft includes all of the outer radial surface.

13. A roller clutch and housing assembly comprising:
at least one of the roller clutch assemblies of claim 1; and
a housing assembly, the housing assembly including an outer cover and an inner cover, the main shaft of the roller clutch assembly being press fit into an opening of the inner cover.

14. A roller clutch and housing assembly comprising:
at least one of the roller clutch assemblies of claim 1; and
a housing assembly, the housing assembly including an outer cover and an inner cover, the main shaft of the roller clutch assembly being integral with the inner cover.

15. A roller clutch and housing assembly comprising:
a roller clutch assembly having:
a beaded chain wheel having a circumferential portion and an inner radial surface;
a beaded chain configured to be received within the circumferential portion of the beaded chain wheel;
a drive adapter having a base and an internal channel, the base including a support surface configured to retain the driver adapter along the inner radial surface of the beaded chain wheel;
a support shaft configured to extend through the internal channel of the drive adapter;
a main shaft positioned around the support shaft; and
a spring positioned around the main shaft, the spring abutting at least a portion of the outer radial surface; and
a housing assembly, the housing assembly including an outer cover, an inner cover, and at least two pulleys coupled to the outer cover, at least one channel positioned between the at least two pulleys, the beaded chain of the roller clutch assembly configured to pass through the at least one channel.

16. The roller clutch and housing assembly of claim 15, wherein the main shaft has an inner radial surface and an outer radial surface, and at least a portion of the outer radial surface is tooled.

17. The roller clutch and housing assembly of claim 15, wherein the at least two pulleys includes three pulleys and the at least one channel includes two channels, a first of the two channels being on a first side of one of the three pulleys and the second of the two channels being on a second side of the one of the three pulleys.

18. The roller clutch and housing assembly of claim 17, wherein each of the two channels extends through a bottom of the housing assembly.

19. The roller clutch and housing assembly of claim 15, wherein one of the at least two pulleys is positioned along a longitudinal axis of the housing assembly.

20. The roller clutch and housing assembly of claim 15, wherein the at least two pulleys includes two pulleys and the at least one channel includes two channels, a first of the two channels being positioned between a first of the two pulleys and an extension of the outer cover and a second of the two channels being positioned a second of the two pulleys and the extension of the outer cover, the extension being positioned between the two pulleys.
